(19) United States
(12) Patent Application Publication
(10) Pub. No.: US 2017/0181458 A1
(43) Pub. Date: Jun. 29, 2017

(54) FRUIT CHEW SUPPLEMENTS

(71) Applicant: Ocean Spray Cranberries, Inc., Lakeville-Middleboro, MA (US)

(72) Inventors: Harold L. Mantius, North Kingstown, RI (US); Min Blundell, Lakeville-Middleboro, MA (US)

(21) Appl. No.: 15/386,540

(22) Filed: Dec. 21, 2016

Related U.S. Application Data
(60) Provisional application No. 62/387,311, filed on Dec. 23, 2015.
(60) Provisional application No. 62/339,584, filed on May 20, 2016.

(51) Int. Cl. A23L 19/00; A23L 33/105

(52) U.S. Cl. CPC A23L 19/09; A23L 33/105; A23V 2002/00

(57) ABSTRACT

The present specification provides fruit chew dietary supplements comprising proanthocyanidins. Also described are methods for producing the fruit chew supplements.

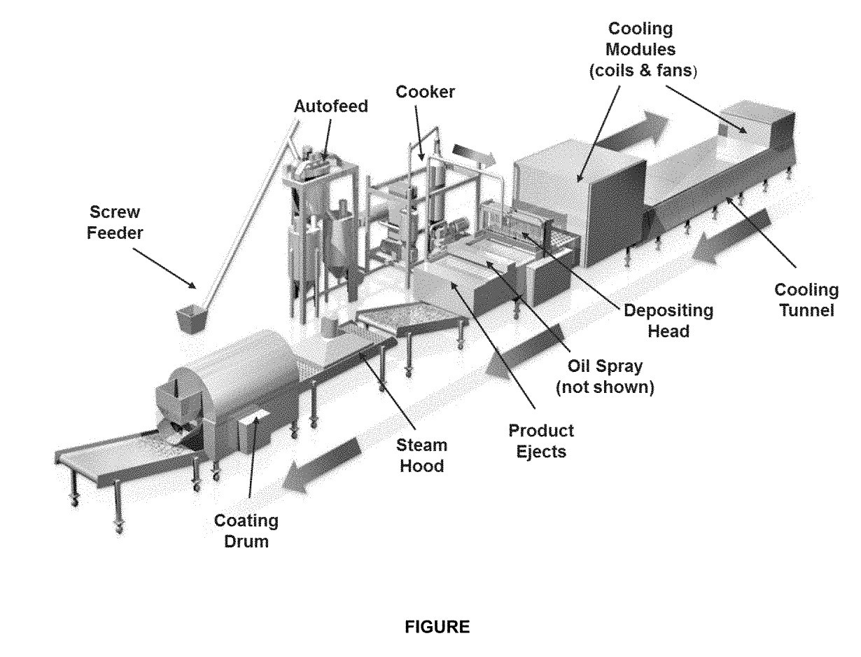

### CROSS-REFERENCE TO RELATED APPLICATIONS

This application claims the benefit of U.S. Application Nos. 62/387,311, filed on Dec. 23, 2015, and 62/339,584, filed on May 20, 2016, which are incorporated by reference herein in their entireties.

### TECHNICAL FIELD

The present disclosure provides, inter alia, fruit chew supplements comprising proanthocyanidins (PACs) and methods of making the fruit chew supplements.

### BACKGROUND

Certain fruits, particularly cranberries, contain a class of compounds known as proanthocyanidins (PACs), which impart unique health benefits. In addition to their anti-adhesion properties against bacteria that can be used to treat urinary tract infections, PACs have antioxidant activity and play a role in the stabilization of collagen and maintenance of elastin, two critical proteins in connective tissue that support organs, joints, blood vessels, and muscle. Common antioxidants currently used are vitamin C and vitamin E; however, studies show that PACs' antioxidant capabilities are twenty times more powerful than vitamin C and fifty times more potent than vitamin E (Shi et al., J Med Food 6:291-9, 2003). PACs strengthen blood vessels and improve the delivery of oxygen to cells by suppressing the production of endothelin-1 protein, which constricts blood vessels (Corder et al., Nature 444:566, 2006). PACs also have an affinity for cell membranes, providing nutritional support to reduce capillary permeability and fragility.

Dietary supplements and pharmaceuticals (collectively “supplements”) are commonly ingested orally to provide health benefits to people and animals. However, known supplements are not entirely satisfactory for the range of applications in which they are employed. For example, existing supplements are often large, hard to swallow, have an unpleasant taste, smell, and/or texture, and often not chewable. The present disclosure provides compositions and methods designed to supplement the nutritional needs of individuals with fruit chew supplements comprising PACs that can be chewed.

### SUMMARY

The present disclosure is based, in part, on the discovery that fruit chew supplements containing PACs with a high level of cranberry acid, e.g., about 2.0% to about 3.2% (w/w), can be produced that have enhanced cranberry flavor and reduced bitterness. Accordingly, in one aspect, the present specification provides methods of making fruit chew supplements. The methods include, for example, providing a mixture comprising apple paste and/or quince paste, fruit syrup and/or fruit concentrates, proanthocyanidin-enriched cranberry concentrate or a blend of cranberry concentrate and PAC-enriched cranberry extract, and water. In some instances, an antioxidant is added, e.g., green tea extract, rosemary extract, acerola extract, ascorbic acid and related compounds, tocopherols, tocotrienols, tertiary-butyl hydroquinone (TBHQ), butylated hydroxyanisole (BHA), butylated hydroxytoluene (BHT), or any combination thereof. For example, the mixture can include an apple paste and/or quince paste content of about 30% to about 90% (w/w), a fruit syrup and/or fruit concentrates content of about 0% to about 60% (w/w), a PAC-enriched cranberry concentrate and/or a blend of cranberry concentrate and PAC-enriched cranberry extract content of about 10% to about 25% (w/w), and an added water content of about 0% to about 15% (w/w). In some instances, antioxidant can be added to the mixture such that each fruit chew supplement comprises about 0 mg to about 200 mg of antioxidant. The method can further include heating the mixture to a temperature of about 165° F. to about 205° F. to provide a cooked mixture; depositing the cooked mixture into a solid mold; and cooling the cooked mixture in the mold to a temperature of about 40° F. to about 65° F. for about 5 minutes to about 30 minutes, to thereby provide a fruit chew supplement.

In some embodiments, the mixture has an apple paste and/or quince paste content of about 38% to about 40% (w/w). In some embodiments, the mixture has a fruit syrup and/or fruit concentrates content of about 38% to about 40% (w/w). In some embodiments, the mixture has a PAC-enriched cranberry concentrate and/or a blend of cranberry concentrate and PAC-enriched cranberry extract content of about 13% to about 18% (w/w). In some embodiments, antioxidant can be added to the mixture such that each fruit chew supplement comprises about 10 mg of antioxidant. In some embodiments, the mixture has an added water content of about 6% to about 7% (w/w). In one embodiment, the mixture has a gelling agent (e.g., pectin), mineral, vitamin, or nutraceutical compound (e.g., herb or other botanical, amino acid, enzyme, organ tissue, glandular, and metabolite), or any combination thereof. In some embodiments, the mixture has an apple paste and/or quince paste content of about 40% (w/w), a fruit syrup and/or fruit concentrates content of about 40% (w/w), a PAC-enriched cranberry concentrate and/or a blend of cranberry concentrate and PAC-enriched cranberry extract content of about 13% (w/w), and an added water content of about 7% (w/w).

In some embodiments, the mixture is of concentrations that provide a final fruit chew supplement comprising a cranberry acid content of about 2.0% to about 3.2% (w/w) and a PAC content of about 0.4% to about 3.2% (w/w). In some embodiments, the mixture is of concentrations that provide a final fruit chew supplement comprising about 20 mg to about 240 mg of PACs. In some embodiments, the methods further include coating the fruit chew supplements with a sugar, glaze, dusting powder, flavoring, sodium alginate-based film, oil (e.g., cranberry seed oil or omega 3 oil), yogurt, chocolate, and/or flow agent. In some embodiments, the fruit chew supplements have a mass of about 1.0 gram to about 10.0 grams.

In yet another aspect, the present specification features fruit chew supplements that have a cranberry acid content of about 2.0% to about 3.2% (w/w) and a PAC content of about 0.4% to about 3.2% (w/w). In some embodiments, the cranberry acid content is about 2.4% (w/w). In some embodiments, the PAC content is about 1.2% (w/w). In some embodiments, the fruit chew supplements have about 20 mg to about 240 mg of PACs.

In some embodiments, the fruit chew supplements have an apple paste and/or quince paste content of about 30% to about 90% (w/w). In some embodiments, the fruit chew supplements have a fruit syrup and/or fruit concentrates content of about 0% to about 60% (w/w). In some embodiments, the fruit chew supplements have a PAC-enriched cranberry concentrate and/or a blend of cranberry concentrate and PAC-enriched cranberry extract content of about 10% to about 25% (w/w). In some embodiments, each fruit chew supplement has an antioxidant content of about 0 mg to about 200 mg. In some embodiments, the fruit chew supplements have an added water content of about 0% to about 15% (w/w). In one embodiment, the fruit chew supplements have a gelling agent (e.g., pectin), mineral, vitamin, or nutraceutical compound (e.g., herb or other botanical, amino acid, enzyme, organ tissue, glandular, and metabolite), or any combination thereof. In some embodiments, the fruit chew supplements have a sugar, glaze, dusting powder, flavoring, sodium alginate based film, oil (e.g., cranberry seed oil and/or omega 3 oil), yogurt, chocolate, and/or flow agent coating. In some embodiments, the fruit chew supplements have a mass of about 1.0 gram to about 10.0 grams.

The levels of PACs in the compositions described herein have been assessed or quantified using Ocean Spray's dimethylaminocinnameldehyde (DMAC) method, which utilizes PACs fractionated from specific cranberry sources as a standard. See, e.g., Martin et al., Food Res Int 71:68-82, 2015; and de Pascual-Teresa et al., J Agric Food Chem 46:4209-4213, 1998, which are hereby incorporated by reference. Skilled practitioners will appreciate that other methods can be used. For example, Brunswick Labs uses a pure commercially available procyanidin A-2/B-2standard (dimer) as a standard. See, e.g., Prior et al., J Sci Food Agric 90:1473-1478, 2010. When a sample is tested for PACs with Ocean Spray's method compared to Brunswick Labs' method, lower PAC values are consistently found using Brunswick Labs' method due to the lower molecular weight of the procyanidinA-2/B-2standard compared to the fractionated PAC standard, which contains A-2/B-2and all the higher molecular weight PAC oligomers and polymers present in cranberries. For example, a sample that has about 110 mg PACs when tested using Ocean Spray's DMAC method, may have only about 36 mg PACs when tested using Brunswick Labs' DMAC method.

Skilled practitioners will recognize that both methods measure the total PACs in a sample, but they differ only in how the results are expressed based on the chosen standard equivalency. Therefore, while the results may differ in using the two methods on the same sample, it does not mean that the levels are different. As a result, it is recommended that testing comparisons of the same material always be made using the same methodology so as to avoid confusion. Both methods are generally used in the industry. Nonetheless, Ocean Spray's method better represents the PACs found in cranberry and therefore, results obtained by this method are a truer representation of the ‘real’ amount of PACs in cranberry samples. Accordingly, all PAC values described herein are determined using Ocean Spray's DMAC method.

As used herein, “about” when used in reference to numerical ranges, cutoffs, or specific values is used to indicate that the recited values may vary by up to as much as 10% from the listed value. Thus, the term “about” is used to encompass variations of ±10% or less, variations of ±5% or less, variations of ±1% or less, variations of ±0.5% or less, or variations of ±0.1% or less from the specified value.

Unless otherwise defined, all technical terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, and other references mentioned herein are incorporated by reference in their entirety. In case of conflict, the present specification, including definitions, will control.

Other features and advantages of the invention will be apparent from the following detailed description and FIGURE, and from the claims.

### DESCRIPTION OF DRAWING

The FIGURE shows an exemplary depositing process and apparatus (Baker Perkins Ltd., Peterborough, UK) that can be used to make the fruit chew supplements.

### DETAILED DESCRIPTION

The present disclosure describes chewable dietary supplements, e.g., fruit chew dietary supplements. Non-beverage cranberry food products with low cranberry acidity, e.g., less than 1.5% (w/w), generally have a weak cranberry flavor. Conversely, non-beverage cranberry food products with elevated cranberry acidity, e.g., greater than 2.0% (w/w), generally tend toward an undesirable level of tartness. Moreover, cranberry products with an elevated level of phenolic compounds, e.g., resin technology-derived cranberry extracts, tend to be highly bitter/astringent. The applicant has surprisingly discovered, however, that cranberry chew supplements of high phenolic content, e.g., at a level corresponding to 120 mg of PACs in a 7.5 g chew, formulated to result in an elevated cranberry acidity, e.g., about 2.0% to about 3.2% (w/w), can yield a finished product of enhanced cranberry flavor that effectively masks the bitterness/astringency of the phenolic compounds present, greatly offsetting the impact of the increase in tartness.

Skilled practitioners will appreciate that fruit chew supplements typically have a firm, chewy, solid-structured texture that is less chewy than a “gummy bear”, fruit gum candy, jujube, or Swedish fish. Skilled practitioner will also appreciate that other textures are possible and within the present invention, e.g., highly chewy supplements having a “gummy bear” type texture, and much softer, less chewy textures, such as a gelatinous-type texture.

The supplements can be produced from a mixture of apple paste and/or quince paste, fruit syrup and/or fruit concentrates, and PAC-enriched cranberry concentrate and/or a blend of cranberry concentrate and PAC-enriched cranberry extract. Optionally, antioxidants and/or water and/or gelling agents (e.g., pectin) and/or minerals and/or vitamins and/or other nutraceutical compounds (e.g., herbs or other botanicals, amino acids, enzymes, organ tissues, glandulars, and metabolites) can be added to the mixture. In some embodiments, the apple paste is a mixture of concentrated apple juice, concentrated apple puree, a gelling agent (e.g., pectin), an acidity regulator (e.g., sodium citrate), and an antioxidant (e.g., ascorbic acid). For example, apple paste is commercially available from Taura Natural Ingredients (Belgium). The fruit chew supplements will be described with Taura “URC® JusFruit” Apple Paste, which has low levels of malic acid, although it will be understood by skilled practitioners that other apple pastes may be used to adjust flavor and/or acidity. Fruit syrup is a sugar extract from fruits. As described herein, the fruit chew supplements can be made with “Fruit Up—Premium” fruit syrup obtained from Wild Valencia, S.A. (Spain), but skilled practitioners will understand that other fruit syrups and/or fruit concentrates may be used.

A PAC-enriched concentrate, such as those described in U.S. Pat. Nos. 7,022,368 and 9,023,413, can be used in the present process. Alternatively, or in addition, a resin-based cranberry extract can be mixed with cranberry concentrate to yield a comparable blend of cranberry concentrate and PAC-enriched cranberry extract.

Optionally, an antioxidant can be added to the fruit chew supplements to, for example, improve shelf life of the supplements. Food grade antioxidants are known in the art and can include, for example, green tea extract, rosemary extract, acerola extract, ascorbic acid and related compounds, tocopherols, tocotrienols, tertiary-butyl hydroquinone (TBHQ), butylated hydroxyanisole (BHA), butylated hydroxytoluene (BHT), or any combination of at least two (e.g., at least three, four, five, six, seven, eight, or at least nine, or more) of such antioxidants.

The fruit chew supplements can be made with a cranberry acid content of about 2.0% to about 3.2% (w/w), e.g., about 2.1% to about 3.2%, about 2.2% to about 3.2%, about 2.3% to about 3.2%, about 2.4% to about 3.2%, about 2.5% to about 3.2%, about 2.2% to about 3.0%, about 2.2% to about 2.8%, about 2.2% to about 2.7%, or about 2.0%, 2.1%, 2.2%, 2.3%, 2.4%, 2.5%, 2.6%, 2.7%, 2.8%, 2.9%, 3.0%, 3.1%, or about 3.2%, and a PAC content of about 0.4% to about 3.2% (w/w), e.g., about 0.5% to about 1.6%, about 0.6% to about 1.6%, about 0.7% to about 1.6%, about 0.8% to about 1.6%, about 0.9% to about 1.6%, about 1.0% to about 1.6%, about 1.1% to about 1.6%, about 1.2% to about 1.6%, about 1.3% to about 1.6%, about 1.4% to about 1.6%, about 1.5% to about 1.6%, about 0.5% to about 3.2%, about 0.6% to about 3.2%, about 0.7% to about 3.2%, about 0.8% to about 3.2%, about 0.9% to about 3.2%, about 1.0% to about 3.2%, about 1.1% to about 3.2%, about 1.2% to about 3.2%, about 1.3% to about 3.2%, about 1.4% to about 3.2%, about 1.5% to about 3.2%, about 1.6% to about 3.2%, about 1.7% to about 3.2%, about 1.8% to about 3.2%, about 1.9% to about 3.2%, about 2.0% to about 3.2%, about 2.1% to about 3.2%, about 2.2% to about 3.2%, about 2.3% to about 3.2%, about 2.4% to about 3.2%, about 2.5% to about 3.2%, about 2.6% to about 3.2%, about 2.7% to about 3.2%, about 2.8% to about 3.2%, about 2.9% to about 3.2%, about 3.0% to about 3.2%, about 3.1% to about 3.2%, about 0.4% to about 1.2%, about 0.5% to about 1.2%, about 0.6% to about 1.2%, about 0.7% to about 1.2%, about 0.8% to about 1.2%, about 0.9% to about 1.2%, about 1.0% to about 1.2%, about 1.1% to about 1.2%, about 0.4% to about 1.6%, about 0.5% to about 1.6%, about 0.6% to about 1.6%, about 0.7% to about 1.6%, about 0.8% to about 1.6%, about 0.9% to about 1.6%, about 1.0% to about 1.6%, about 1.1% to about 1.6%, about 1.2% to about 1.6%, about 1.3% to about 1.6%, about 1.4% to about 1.6%, about 1.5% to about 1.6%, about 0.5% to about 0.9%, about 0.4% to about 0.9%, about 0.5% to about 0.8%, about 0.5% to about 1.5%, about 0.7% to about 1.3%, about 1.0% to about 1.2%, or about 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, or about 3.2%.

A mixture of apple paste and/or quince paste, fruit syrup and/or fruit concentrates, PAC-enriched cranberry concentrate and/or a blend of cranberry concentrate and PAC-enriched cranberry extract, and water can be heated to cook the mixture. See, Table 1. Optionally, antioxidants can be added to the mixture such that each fruit chew supplement comprises about 0 mg to about 200 mg of antioxidant. Heating can be performed using any method known in the art. The mixture can have an apple paste and/or quince paste content of about 30% to about 33% (w/w), e.g., about 33% to about 50%, about 35% to about 50%, about 37% to about 50%, about 40% to about 50%, about 42% to about 50%, about 45% to about 50%, about 47% to about 50%, about 30% to about 85%, about 33% to about 85%, about 35% to about 85%, about 37% to about 85%, about 40% to about 85%, about 42% to about 85%, about 45% to about 85%, about 47% to about 85%, 50% to about 85%, about 52% to about 85%, about 55% to about 85%, about 57% to about 85%, about 60% to about 85%, about 62% to about 85%, about 65% to about 85%, 67% to about 85%, about 70% to about 85%, about 73% to about 85%, about 75% to about 85%, about 78% to about 85%, about 80% to about 85%, about 82% to about 85%, about 30% to about 87%, about 30% to about 85%, about 30% to about 83%, about 30% to about 80%, about 30% to about 78%, about 30% to about 75%, about 30% to about 73%, about 30% to about 70%, about 30% to about 67%, about 30% to about 65%, about 30% to about 62%, about 30% to about 60%, about 30% to about 57%, about 30% to about 55%, about 30% to about 52%, about 30% to about 50%, about 30% to about 48%, about 30% to about 45%, about 30% to about 42%, about 30% to about 40%, about 30% to about 37%, about 30% to about 35%, about 30% to about 33%, about 37% to about 41%, about 38% to about 40%, about 38% to about 42%, about 39% to about 42%, about 39% to about 41%, about 35% to about 80%, about 40% to about 75%, about 45% to about 70%, about 50% to about 65%, about 55% to about 60%, about 33% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, or about 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

The mixture can have a fruit syrup and/or fruit concentrates content of about 0% to about 60% (w/w), e.g., about 33% to about 50%, about 35% to about 50%, about 37% to about 50%, about 40% to about 50%, about 42% to about 50%, about 45% to about 50%, about 47% A to about 50%, about 1% to about 60%, about 3% to about 60%, about 5% to about 60%, about 8% to about 60%, about 10% to about 60%, about 12% to about 60%, about 15% to about 60%, about 18% to about 60%, about 20% to about 60%, about 22% to about 60%, about 25% to about 60%, about 28% to about 60%, about 30% to about 60%, about 33% to about 60%, about 35% to about 60%, about 38% to about 60%, about 40% to about 60%, about 43% to about 60%, about 45% to about 60%, about 48% to about 60%, about 50% to about 60%, about 52% to about 60%, about 55% to about 60%, about 57% to about 60%, about 30% to about 48%, about 30% to about 45%, about 30% to about 42%, about 30% to about 40%, about 30% to about 37%, about 30% to about 35%, about 30% to about 33%, about 0% to about 58%, about 0% to about 55%, about 0% to about 52%, about 0% to about 50%, about 0% to about 48%, about 0% to about 45%, about 0% to about 42%, about 0% to about 40%, about 0% to about 38%, about 0% to about 35%, about 0% to about 33%, about 0% to about 30%, about 0% to about 28%, about 0% to about 25%, about 0% to about 22%, about 0% to about 20%, about 0% to about 18%, about 0% to about 15%, about 0% to about 12%, about 0% to about 10%, about 0% to about 8%, about 0% to about 5%, about 0% to about 2%, about 37% to about 41%, about 38% to about 40%, about 38% to about 42%, about 39% to about 42%, about 39% to about 41%, about 5% to about 55%, about 10% to about 50%, about 15% to about 45%, about 20% to about 40%, about 25% to about 35%, or about 1%, 3%, 5%, 8%, 10%, 12%, 15%, 17%, 20%, 22%, 25%, 28%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or about 60%.

Depending on the properties of the PAC-enriched cranberry concentrate and/or the blend of cranberry concentrate and PAC-enriched cranberry extract, the PAC-enriched cranberry concentrate and/or blend of cranberry concentrate and PAC-enriched cranberry extract content of the mixture can be, e.g., about 10% to about 25% (w/w), e.g., about 12% to about 25%, about 15% to about 25%, about 17% to about 25%, about 20% to about 25%, about 22% to about 25%, about 10% to about 22%, about 10% to about 20%, about 10% to about 17%, about 10% to about 15%, about 10% to about 12%, about 12% to about 19%, about 13% to about 18%, about 14% to about 17%, or about 11%, 12%, 13%, 14%, 15%, 16%, 17%, 18%, 19%, 20%, 21%, 22%, 23%, or about 24%. Skilled practitioners will be able to readily calculate the amount of PAC-enriched cranberry concentrate and/or blend of cranberry concentrate and PAC-enriched cranberry extract needed in the mixture to produce a fruit chew supplement with a cranberry acid content of about 2.0% to about 3.2% (w/w) and a PAC content of about 0.4% to about 3.2% (w/w) based on the cranberry acid content and PAC content of the PAC-enriched cranberry concentrate or the blend of cranberry concentrate and PAC-enriched cranberry extract.

The mixture can have an antioxidant content such that each fruit chew supplement comprises about 0 mg to about 200 mg of antioxidant, e.g., about 1 mg to about 10 mg, about 5 mg to about 10 mg, about 1 mg to about 180 mg, about 2 mg to about 150 mg, about 5 mg to about 150 mg, about 10 mg to about 100 mg, about 25 mg to about 100 mg, about 50 mg to about 100 mg, about 50 mg to about 200 mg, about 100 mg to about 200 mg, about 150 mg to about 200 mg, or about 0 mg, 1 mg, 2 mg, 5 mg, 10 mg, 15 mg, 20 mg, 25 mg, 30 mg, 50 mg, 100 mg, 120 mg, 150 mg, 180 mg, or about 200 mg of antioxidant per fruit chew supplement. In some instances, the antioxidant can be added to the mixture prior to, during, or after heating the mixture, or any combination thereof. For example, the antioxidant can be added prior to and during heating the mixture, prior to and after heating the mixture, prior to, during, and after heating the mixture, or during and after heating the mixture.

The remainder of the mixture can have, e.g., an added water content of about 0% to about 15% (w/w), e.g., about 3% to about 12%, about 5% to about 10%, about 5% to about 15%, about 2% to about 10%, about 5% to about 8%, about 6% to about 7%, about 6% to about 8%, about 5% to about 7%, or about 1%, 2%, 3%, 4%, 5%, 6%, 7%, 8%, 9%, 10%, 11%, 12%, 13%, 14%, or about 15%.

TABLE 1
Components in Fruit Chew Supplements

| INGREDIENT | PERCENTAGE |
|---|---|
| Apple Paste and/or Quince Paste | 30-90% |
| Fruit Syrup and/or Fruit Concentrates | 0-60% |
| PAC-Enriched Cranberry Concentrate | 10-25% |
| and/or a Blend of Cranberry Concentrate | |
| and PAC-Enriched Cranberry Extract | |
| Water | 0-15% |
| Total | 100% |

Any number of molding or extrusion processes and equipment can be used to make the fruit chew supplements described herein. One example of a particularly useful apparatus is a SERVOGEL™ Starchless Moulding Process (Baker Perkins Ltd., Peterborough, UK). See, FIGURE. Skilled practitioners will appreciate that other methods or apparatuses can potentially be used to heat, deposit, mold, and cool the mixture to form a fruit chew supplement, e.g., forming large molded sheets of supplement that are then sliced and separated into ribbons and guillotine cut into individual pieces.

The mixture can be cooked using any art-known technique, e.g., under vacuum to minimize heat abuse, at a temperature of about 165° F. to about 205° F., e.g., about 170° F. to about 205° F., about 175° F. to about 205° F., about 180° F. to about 205° F., about 185° F. to about 205° F., about 190° F. to about 205° F., about 195° F. to about 205° F., about 200° F. to about 205° F., about 165° F. to about 200° F., about 165° F. to about 195° F., about 165° F. to about 190° F., about 165° F. to about 185° F., about 165° F. to about 180° F., about 165° F. to about 175° F., about 165° F. to about 170° F., about 170° F. to about 180° F., or about 167° F., 170° F., 172° F., 175° F., 178° F., 180° F., 182° F., 185° F., 187° F., 190° F., 192° F., 195° F., 197° F., 200° F., or about 202° F., to provide a cooked mixture with a soluble solids content of about 79° Brix to about 89° Brix, e.g., about 79° Brix to about 86° Brix, about 79° Brix to about 84° Brix, about 79° Brix to about 82° Brix, about 81° Brix to about 89° Brix, about 83° Brix to about 89° Brix, about 86° Brix to about 89° Brix, or about 80° Brix, 81° Brix, 82° Brix, 83° Brix, 84° Brix, 85° Brix, 86° Brix, 87° Brix, or about 88° Brix. The cooked mixture is deposited into a solid mold to form a supplement with a certain size, shape, and weight. After depositing the cooked mixture into a mold, the mixture is cooled in the mold using any art-known technique, e.g., refrigeration or allowing to stand at a lower temperature, to a temperature of about 40° F. to about 65° F., e.g., about 42° F. to about 65° F., about 45° F. to about 65° F., about 47° F. to about 65° F., about 50° F. to about 65° F., about 52° F. to about 65° F., about 55° F. to about 65° F., about 57° F. to about 65° F., about 60° F. to about 65° F., about 62° F. to about 65° F., about 40° F. to about 62° F., about 40° F. to about 60° F., about 40° F. to about 57° F., about 40° F. to about 55° F., about 40° F. to about 52° F., about 40° F. to about 50° F., about 40° F. to about 47° F., about 40° F. to about 45° F., about 40° F. to about 42° F., or about 41° F., 42° F., 43° F., 44° F., 45° F., 46° F., 47° F., 48° F., 49° F., 50° F., 51° F., 52° F., 53° F., 54° F., 55° F., 56° F., 57° F., 58° F., 59° F., 60° F., 61° F., 62° F., 63° F., or about 64° F., for about 5 minutes to about 30 minutes, e.g., about 5 minutes to about 25 minutes, about 5 minutes to about 20 minutes, about 10 minutes to about 25 minutes, about 10 minutes to about 20 minutes, about 5 minutes to about 10 minutes, about 10 minutes to about 15 minutes, about 7 minutes to about 12 minutes, or about 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, or about 29 minutes, to provide a fruit chew supplement.

The fruit chew supplements formed by cooling the cooked, deposited mixture can be released from the molds by any method in the art. For example, the supplements can be extracted from the molds manually, or preferably, by using air to eject the supplement from the mold. If needed, a release agent, e.g., food-grade oil, can be used to aid in the discharge of product from the mold. For example, CAPOL® 4728 (Germany), which is a carnauba wax/vegetable oil blend, can be used as a release agent.

The fruit chew supplements are formulated to have a pleasant taste, smell and a desirable mouthfeel to enhance its palatability and to encourage subjects to ingest the PACs that are incorporated into the fruit chew supplements. In the present example, fruit chew supplements are configured to be chewed and swallowed in less than about 30 seconds, e.g., less than about 20 seconds, to make consuming the fruit chew supplement a generally pleasant and non-laborious undertaking. Fruit chew supplements can be formulated to impart a wide variety of flavors, aromas, textures, and colors depending on a subject's preference.

The fruit chew supplements may be made in a variety of sizes and weights to serve as a pleasing and appropriate supplement for different people. For example, adults may prefer a larger fruit chew supplement, whereas children may prefer a smaller fruit chew supplement. The size and weight of the fruit chew supplement may be varied depending on the amount of PACs to be delivered to the person ingesting the fruit chew supplement. In some examples, the fruit chew supplement has a mass of about 1.0 gram to about 10.0 grams, e.g., about 1.0 gram to about 9.0 grams, about 1.0 gram to about 8.0 grams, about 1.0 gram to about 7.0 grams, about 1.0 gram to about 6.0 grams, about 1.0 gram to about 5.0 grams, about 1.0 gram to about 4.0 grams, about 1.0 gram to about 3.0 grams, about 1.0 gram to about 2.0 grams, about 2.0 grams to about 10.0 grams, about 3.0 grams to about 10.0 grams, about 4.0 grams to about 10.0 grams, about 5.0 grams to about 10.0 grams, about 6.0 grams to about 10.0 grams, about 7.0 grams to about 10.0 grams, about 8.0 grams to about 10.0 grams, about 9.0 grams to about 10.0 grams, or about 1.5, 2.0, 2.5, 3.0, 3.5, 4.0, 4.5, 5.0, 5.5, 6.0, 6.5, 7.0, 7.5, 8.0, 8.5, 9.0, or about 9.5 grams. However, heavier and lighter fruit chew supplements are contemplated. The supplements may contain about 20 mg to about 240 mg of PACs per piece, e.g., about 25 mg to about 160 mg, about 30 mg to about 160 mg, about 35 mg to about 160 mg, about 40 mg to about 160 mg, about 45 mg to about 160 mg, about 50 mg to about 160 mg, about 55 mg to about 160 mg, about 60 mg to about 160 mg, about 65 mg to about 160 mg, about 70 mg to about 160 mg, about 75 mg to about 160 mg, about 80 mg to about 160 mg, about 85 mg to about 160 mg, about 90 mg to about 160 mg, about 95 mg to about 160 mg, about 100 mg to about 160 mg, about 105 mg to about 160 mg, about 110 mg to about 160 mg, about 115 mg to about 160 mg, about 120 mg to about 160 mg, about 125 mg to about 160 mg, about 130 mg to about 160 mg, about 135 mg to about 160 mg, about 140 mg to about 160 mg, about 145 mg to about 160 mg, about 150 mg to about 160 mg, about 155 mg to about 160 mg, about 25 mg to about 240 mg, about 30 mg to about 240 mg, about 35 mg to about 240 mg, about 40 mg to about 240 mg, about 45 mg to about 240 mg, about 50 mg to about 240 mg, about 55 mg to about 240 mg, about 60 mg to about 240 mg, about 65 mg to about 240 mg, about 70 mg to about 240 mg, about 75 mg to about 240 mg, about 80 mg to about 240 mg, about 85 mg to about 240 mg, about 90 mg to about 240 mg, about 95 mg to about 240 mg, about 100 mg to about 240 mg, about 105 mg to about 240 mg, about 110 mg to about 240 mg, about 115 mg to about 240 mg, about 120 mg to about 240 mg, about 125 mg to about 240 mg, about 130 mg to about 240 mg, about 135 mg to about 240 mg, about 140 mg to about 240 mg, about 145 mg to about 240 mg, about 150 mg to about 240 mg, about 155 mg to about 240 mg, about 160 mg to about 240 mg, about 165 mg to about 240 mg, about 170 mg to about 240 mg, about 175 mg to about 240 mg, about 180 mg to about 240 mg, about 185 mg to about 240 mg, about 190 mg to about 240 mg, about 195 mg to about 240 mg, about 200 mg to about 240 mg, about 205 mg to about 240 mg, about 210 mg to about 240 mg, about 215 mg to about 240 mg, about 220 mg to about 240 mg, about 225 mg to about 240 mg, about 230 mg to about 240 mg, about 235 mg to about 240 mg, about 20 mg to about 235 mg, about 20 mg to about 230 mg, about 20 mg to about 225 mg, about 20 mg to about 220 mg, about 20 mg to about 215 mg, about 20 mg to about 210 mg, about 20 mg to about 205 mg, about 20 mg to about 200 mg, about 20 mg to about 195 mg, about 20 mg to about 190 mg, about 20 mg to about 185 mg, about 20 mg to about 180 mg, about 20 mg to about 175 mg, about 20 mg to about 170 mg, about 20 mg to about 165 mg, about 20 mg to about 160 mg, about 20 mg to about 155 mg, about 20 mg to about 150 mg, about 20 mg to about 145 mg, about 20 mg to about 140 mg, about 20 mg to about 135 mg, about 20 mg to about 130 mg, about 20 mg to about 125 mg, about 20 mg to about 120 mg, about 20 mg to about 115 mg, about 20 mg to about 110 mg, about 20 mg to about 105 mg, about 20 mg to about 100 mg, about 20 mg to about 95 mg, about 20 mg to about 90 mg, about 20 mg to about 85 mg, about 20 mg to about 80 mg, about 20 mg to about 75 mg, about 20 mg to about 70 mg, about 20 mg to about 65 mg, about 20 mg to about 60 mg, about 20 mg to about 55 mg, about 20 mg to about 50 mg, about 20 mg to about 45 mg, about 20 mg to about 40 mg, about 20 mg to about 35 mg, about 20 mg to about 30 mg, about 20 mg to about 25 mg, or about 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, or about 240 mg per piece.

Fruit chew supplements, as described herein, may be formed into a wide variety of shapes, e.g., square, rectangle, sphere, oval, animals, or gumdrops. Suitable shapes are those that provide sufficient structural integrity while also providing the subject with a readily consumable and pleasing shape. Non-limiting examples of suitable shapes for the fruit chew supplements include cubes, boxes, spheres, ovals, coin-shaped compositions, gumdrop or raindrop shapes, pyramids, disks, and irregular shapes. Further, suitable shapes include life-form based shapes, such as animals, including monkeys, lions, bears, worms, or fish, plants, trees, flowers, or people. Other suitable shapes include shapes of objects, such as cars, houses, cell phones, or money.

The fruit chew supplement can be coated with a finishing agent using a sugar coat, glaze, dusting powder, flavoring, sodium alginate-based film, yogurt, oil (e.g., cranberry seed oil and/or omega 3 oil), and/or chocolate. The supplements can also be treated with a flow agent comprising particles of dried and milled skin, hull, seeds, or any combination thereof, of a cranberry to improve flowability, i.e., lower cohesion and/or adhesion to processing equipment, using any method known in the art. See, e.g., WO 2014/160064. In an exemplary method, the fruit chew supplements are substantially coated with a finishing agent by mixing the supplements with the finishing agent in a tumbler or sprinkling and shaking the finishing agent over the fruit chew supplements to coat greater than or about 50% of the surface area of the fruit chew supplement, e.g., greater than or about 55%, 60%, 65%, 70%, 75%, 80%, 85%, 90%, or greater than or about 95% of the surface area of the fruit chew supplement. Skilled practitioners will appreciate that the fruit chew supplements may not need to be covered entirely with finishing agent in order to obtain some of the benefits of the finishing agent, i.e., in some instances, a partial covering may suffice, e.g., a finishing agent covering greater than or about 1% to less than or about 50% of the surface area of the fruit chew supplement, e.g., about 45%, 40%, 35%, 30%, 25%, 20%, 15%, 10%, or about 5% of the surface area of the fruit chew supplement. Optionally, after coating the fruit chew supplements with finishing agent, the fruit chew supplements can be processed, e.g., passed through a screen, to remove excess finishing agent.

The fruit chew supplements can be packaged individually or in bulk, e.g., in packs of two or more supplements. For example, the fruit chew supplements can be packaged in packs of about 2 to about 30 supplements, e.g., about 2 to about 10, about 5 to about 10, about 5 to about 15, about 10 to about 15, about 10 to about 20, about 15 to about 20, about 15 to about 25, or about 20 to about 30 supplements. Alternatively, the fruit chew supplements can be packaged in packs of about 30 to about 2500 supplements, e.g., about 35 to about 2200, about 40 to about 2000, about 50 to about 1500, about 100 to about 1000, about 500 to about 1500, about 800 to about 1200, about 500 to about 1000, or about 50, 60, 70, 80, 90, 100, 200, 300, 400, 500, 800, 1000, 1200, 1500, 1800, 2000, 2200, or about 2500 supplements. Skilled practitioners will appreciate that it may be advantageous to protect the fruit chew supplements from damaging light, moisture, and/or oxygen to, e.g., extend shelf life, reduce off-tastes, protect product colors, and/or safeguard vitamin levels. Therefore, opaque packaging or films that block light, e.g., Pentalabel eklipse film from Klockner Pentaplast, may be used. Other films that can be used to package the fruit chew supplements include 60HB-70MET, 60HB-70PP, and 70-70MET films (Clear Lam Packaging, Inc., Elk Grove Village, Ill.), which act as an oxygen and/or moisture barrier. Packaging that can both act as a moisture barrier (e.g., to retain moisture in the supplements) and keep exposure of the supplement to oxygen low (e.g., to prevent or delay oxidation) are useful in the present compositions and methods.

### EXAMPLES

The invention is further described in the following examples, which do not limit the scope of the invention described in the claims.

### Example 1

A mixture of apple paste, fruit syrup, PAC-enriched cranberry concentrate, and water was made according to the recipe below. The raw mixture, which had a soluble solids content of 74° Brix, was cooked to 82° Brix. 260 g of PAC-enriched cranberry concentrate was added to yield an 80° Brix mixture after additions. The cooked mixture was then deposited into 7.5 g oval-shaped metal molds and allowed to cool at 14° C. for 9.5 minutes. The resultant fruit chew supplements with a targeted 108 mg of PACs per piece were easily released from the molds using air ejection and Capol 4872.

Recipe 150728-1
Copper Pan Benchtop Cooker

| Recipe | % | Grams |
|---|---|---|
| Taura Apple Paste | 38.2 | 1330 |
| Wild Fruit Up | 38.2 | 1330 |
| Water | 6.7 | 232 |
| 50° Brix High PAC Cranberry Concentrate | 9.4 | 325.5 |
| 50° Brix High PAC Cranberry Concentrate | 7.5 | 260 |
| Total | 100 | 3477.5 |

### Example 2

A mixture of apple paste, fruit syrup, PAC-enriched cranberry concentrate, and water was made according to the recipe below. The raw mixture, which had a soluble solids content of 75° Brix, was cooked to 82° Brix. 108.5 g of PAC-enriched cranberry concentrate was added to the cooked mixture. The cooked mixture was then deposited into 7.5 g oval-shaped metal molds and allowed to cool at 14° C. for 10 minutes, with the resultant fruit chew supplements flipped after 5 minutes. The resultant fruit chew supplements with a targeted 80 mg of PACs per piece were easily released from the molds using air ejection and Capol 4872.

Recipe 150728-5
Copper Pan Benchtop Cooker

| Recipe | % | Grams |
|---|---|---|
| Taura Apple Paste | 40.0 | 1330 |
| Wild Fruit Up | 40.0 | 1330 |
| Water | 7.0 | 232 |
| 50° Brix High PAC Cranberry Conc. | 9.8 | 325.5 |
| 50° Brix High PAC Cranberry Conc. | 3.3 | 108.5 |
| Total | 100 | 3326 |

### Example 3

A mixture of apple paste, fruit syrup, PAC-enriched cranberry concentrate and water was made according to the recipe below. The raw mixture, which had a soluble solids content of 75° Brix, was cooked to 82° Brix. 108.5 grams of PAC-enriched cranberry concentrate was then added to a 2.6 kg aliquot of the cooked mixture, which was then deposited in 7.5 g oval-shaped metal molds and allowed to cool at 14° C. for 10 minutes, with the resultant fruit chew supplements flipped after 5 minutes. The resultant fruit chew supplements with a targeted 80 mg of PACs per piece were easily released from the molds using air ejection and Capol 4872.

Recipe 150729-1
Continuous Microfilm Cooker

| Recipe | % | kg |
|---|---|---|
| Taura Apple Paste | 42.3 | 25 |
| Wild Fruit up | 42.3 | 25 |
| Water | 5.2 | 3.05 |
| 50° Brix High PAC Cranberry Concentrate | 10.3 | 6.12 |
| Total | 100 | 59.17 |

### Example 4

A mixture of apple paste, fruit syrup, PAC-enriched cranberry concentrate, and water was made according to the recipe below. The raw mixture, which had a soluble solids content of 74° Brix, was cooked to 80° Brix. The cooked mixture was then deposited into 7.5 g oval-shaped metal molds and allowed to cool at 14° C. for 10 minutes, with the fruit chew supplements flipped after 5 minutes. As product cooled, it showed signs of setting. The resultant fruit chew supplements with a targeted 80 mg of PACs per piece were easily released from the molds using air ejection and Capol 4872.

Recipe 150729-2
Copper Pan Benchtop Cooker

| Recipe | % | Grams |
|---|---|---|
| Taura Apple Paste | 40.0 | 1330 |
| Wild Fruit up | 40.0 | 1330 |
| Water | 7.0 | 232 |
| 50° Brix High PAC Cranberry Conc. | 13.0 | 434 |
| Total | 100 | 3326 |

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A fruit chew supplement comprising a cranberry acid content of about 2.0% to about 3.2% (w/w) and a proanthocyanidin content of about 0.4% to about 3.2% (w/w).

2. The fruit chew supplement of claim 1, wherein the cranberry acid content is about 2.4% (w/w).

3. The fruit chew supplement of claim 1, wherein the proanthocyanidin content is about 1.2% (w/w).

4. The fruit chew supplement of claim 1, wherein the fruit chew supplement comprises about 20 mg to about 240 mg of proanthocyanidins.

5. The fruit chew supplement of claim 1, wherein the fruit chew supplement comprises an apple paste and/or quince paste content of about 30% to about 90% (w/w).

6. The fruit chew supplement of claim 1, wherein the fruit chew supplement comprises a fruit syrup and/or fruit concentrates content of about 0% to about 60% (w/w).

7. The fruit chew supplement of claim 1, wherein the fruit chew supplement comprises a proanthocyanidin-enriched cranberry concentrate and/or a blend of cranberry concentrate and proanthocyanidin-enriched cranberry extract content of about 10% to about 25% (w/w).

8. The fruit chew supplement of claim 1, wherein the fruit chew supplement comprises an antioxidant content of about 0 mg to about 200 mg.

9. The fruit chew supplement of claim 8, wherein the antioxidant comprises green tea extract, rosemary extract, acerola extract, ascorbic acid and related compounds, tocopherol, tocotrienol, tertiary-butyl hydroquinone (TBHQ), butylated hydroxyanisole (BHA), butylated hydroxytoluene (BHT), or any combination thereof.

10. The fruit chew supplement of claim 1, wherein the fruit chew supplement comprises an added water content of about 0% to about 15% (w/w).

11. The fruit chew supplement of claim 1, wherein the fruit chew supplement comprises a gelling agent, mineral, vitamin, or nutraceutical compound, or any combination thereof.

12. The fruit chew fruit chew supplement of claim 1, wherein the fruit chew supplement comprises a sugar, glaze, dusting powder, flavoring, sodium alginate based film, oil, yogurt, chocolate, and/or flow agent coating.

13. The fruit chew fruit chew supplement of claim 12, wherein the fruit chew supplement comprises oil, and wherein the oil comprises cranberry seed oil or omega 3 oil or both.

14. The fruit chew supplement of claim 1, wherein the fruit chew supplement has a mass of about 1.0 gram to about 10.0 grams.

15. A method of making a fruit chew supplement, the method comprising:
heating a mixture comprising an apple paste and/or quince paste content of about 30% to about 90% (w/w), a fruit syrup and/or fruit concentrates content of about 0% to about 60% (w/w), a proanthocyanidin-enriched cranberry concentrate and/or a blend of cranberry concentrate and proanthocyanidin-enriched cranberry extract content of about 10% to about 25% (w/w), and an added water content of about 0% to about 15% (w/w) to a temperature of about 165° F. to about 205° F. to provide a cooked mixture;
depositing the cooked mixture into a solid mold;
cooling the cooked mixture in the mold to a temperature of about 40° F. to about 65° F. for about 5 minutes to about 30 minutes, to thereby provide a fruit chew supplement.

16. The method of claim 15, wherein the mixture comprises an apple paste and/or quince paste content of about 38% to about 40% (w/w).

17. The method of claim 15, wherein the mixture comprises a fruit syrup and/or fruit concentrates content of about 38% to about 40% (w/w).

18. The method of claim 15, wherein the mixture comprises a proanthocyanidin-enriched cranberry concentrate and/or a blend of cranberry concentrate and proanthocyanidin-enriched cranberry extract content of about 13% to about 18% (w/w).

19. The method of claim 15, wherein the mixture optionally further comprises an antioxidant, and the mixture is of concentrations that provide a final fruit chew supplement comprising about 0 mg to about 200 mg of antioxidant.

20. The method of claim 19, wherein the antioxidant comprises green tea extract, rosemary extract, acerola extract, ascorbic acid and related compounds, tocopherol, tocotrienol, tertiary-butyl hydroquinone (TBHQ), butylated hydroxyanisole (BHA), butylated hydroxytoluene (BHT), or any combination thereof.

21. The method of claim 15, wherein the mixture comprises an added water content of about 6% to about 7% (w/w).

22. The method of claim 15, wherein the mixture further comprises a gelling agent, mineral, vitamin, or nutraceutical compound, or any combination thereof.

23. The method of claim 15, wherein the mixture comprises an apple paste and/or quince paste content of about 40% (w/w), a fruit syrup and/or fruit concentrates content of about 40% (w/w), a proanthocyanidin-enriched cranberry concentrate and/or a blend of cranberry concentrate and proanthocyanidin-enriched cranberry extract content of about 13% (w/w), and an added water content of about 7% (w/w).

24. The method of claim 15, wherein the mixture is of concentrations that provide a final fruit chew supplement comprising a cranberry acid content of about 2.0% to about 3.2% (w/w) and a proanthocyanidin content of about 0.4% to about 3.2% (w/w).

25. The method of claim 15, wherein the mixture is of concentrations that provide a final fruit chew supplement comprising about 20 mg to about 240 mg of proanthocyanidins.

26. The method of claim 15, wherein the method further comprises coating the fruit chew supplement with a sugar, glaze, dusting powder, flavoring, sodium alginate-based film, oil, yogurt, chocolate, and/or flow agent.

27. The method of claim 26, wherein the method comprises coating the fruit chew supplement with oil, and wherein the oil comprises cranberry seed oil or omega 3 oil or both.

28. The method of claim 15, wherein the fruit chew supplement has a mass of about 1.0 gram to about 10.0 grams.
